(19) United States
(12) Patent Application Publication
(10) Pub. No.: US 2015/0130972 A1
(43) Pub. Date: May 14, 2015

(54) Self-Adaptive Lens Shading Calibration and Correction

(71) Applicant: OmniVision Technologies, Inc., Santa Clara, CA (US)

(72) Inventors: Chengming Liu, San Jose, CA (US); Jizhang Shan, Cupertino, CA (US); Donghui Wu, Sunnyvale, CA (US); Xiaoyong Wang, Santa Clara, CA (US); Changmeng Liu, San Jose, CA (US)

(73) Assignee: OmniVision Technologies, Inc., Santa Clara, CA (US)

(21) Appl. No.: 14/076,665

(22) Filed: Nov. 11, 2013

(51) Int. Cl. H04N 5/357; H04N 5/374

(52) U.S. Cl. CPC H04N 5/3572; H04N 5/374
USPC 348/251

(57) ABSTRACT

A CMOS imaging system is capable of self-calibrating to correct for lens shading by use of images captured in the normal environment of use, apart from a production calibration facility.

### BACKGROUND

Lens shading or vignetting is a problematic phenomenon in image sensors. Broadly speaking, the nature of the problem is that light striking the middle of the sensor array produces a stronger signal than does light striking upon a radius extending out from the middle of a sensor. The problem may have many different origins. Mechanical shading occurs when the sensor receives light travelling from points that are off-axis to the optimal orientation of the sensor. This light may be blocked by thick filters and secondary lenses. Optical shading occurs due to the physical dimensions of a single element or multiple element lens. Rear lenses are shaded by front lenses, which may prevent off-axis light from reaching the rear lens. Shading also occurs naturally according to the Cosine Fourth law, which holds that the falloff of light intensity is approximated by the equation cos(α)⁴, where α is the angle light impinges upon the sensor array. Digital cameras are affected by the angle dependence of digital sensors where light incident on the sensor array at a right angle to the array produces a stronger signal than does light impinging upon the sensor array at an oblique angle.

Digital imaging devices benefit from calibrations that compensate for lens shading. United States Patent Publication US 2005/0179793 to Schweng proposes to do this algorithmically by calculating a correction factor based upon the distance of each pixel from the center of the sensor array. This calculation may be performed for each pixel in the sensor array, although the '793 publication recognizes also that it is sometimes not necessary to compensate pixels at the center of the array.

United States Patent Publication US 2010/0165144 to Lee demonstrates a process of correcting for lens shading in color image sensors. This process entails exposing the sensor array to light from various sources, which may be sources of white light. These include lighting sources that are well known to the art for use in lens shading calibration, including D65, cool white fluorescent (CWF), and Type A flat field sources. The disclosure teaches that, after calibration, the sensor array may sense what type of light it is receiving and make a gain adjustment based upon this sense operation. If the sensor senses that the captured light is in between two measured types of light, then uses a second order polynomial to adjust the correction factors for each pixel in calculating a scene adjustment surface.

United States Patent Publication US 2009/0322892 to Smith et al. also describes a module level shading test where each sensor module is exposed to multiple illumination sources. A preproduction sensor module is used to capture several sets of flatfield images under selected illuminants. These images are transformed, normalized, and stored. In the production phase, a sensor module under that is undergoing calibration captures a test image. The system retrieves the stored normalized images and performs a pixel multiplication operation that uses values from the captured image to convert the stored normalized image values for use in calibrating the sensor module that is undergoing calibration.

Problems with the foregoing techniques include variations from module to module that may be very large and so also are not amenable to transfer of the same algorithmic calibrations without individually calibrating each module by the transfer of images to that very module. Moreover, the flatfield images are specially constructed for calibration purposes, so the resulting calibration is removed from and not adaptable to real images as these are captured in the intended environment of use. This is especially true for nonuniformities caused by the angle dependence of digital sensors. Moreover, the commercial sources of illumination are spectral light types that are detected using spectral information as sensed from the detector. In a color CMOS imaging system, the spectral distribution affects the spatial distribution on the sensor, which is corrected using calibration factors for the white balance gain feedback. The limited types of light sources used in commercial production calibrations are poorly suited to represent all lighting situations that will be encountered in the intended environment of use.

### SUMMARY

The present disclosure overcomes the problems outlined above and advances the art by providing a digital imaging system with a capacity for self-adaptive lens shading calibrations that use captured images from the intended environment of use as a basis for the calibration. Thus, it is no longer necessary to calibrate exclusively on the basis of carefully controlled flatfield images in a factory production setting. In particular, the disclosed embodiments permit calibration for nonuniformities caused by spectral variations, as well as the angle dependence of digital sensors

In one embodiment, a CMOS imaging system includes a housing for the CMOS imaging system. A CMOS sensor array is mounted on the housing. At least one lens is configured to direct light towards the CMOS sensor array. Circuitry governs operation of the CMOS sensor array. The circuitry is operably configured with program instructions for calibrating lens shading. The program instructions are operable for:
optionally detecting a light type from ambient light in a normal imaging environment apart from a calibration setup;
applying a predetermined calibrated light profile to correct for lens shading according to the detected light type;
estimating residual lens shading in a radially outboard direction taken generally from a center of the CMOS sensor array to produce a shading estimate;
compensating for the residual shading under ambient light by use of the shading estimate; and
updating the lens profile under current light type.
In one aspect, the program instructions may provide further for refining the lens profile with successive capture of additional images.

### BRIEF DESCRIPTION OF THE DRAWINGS

FIG. 1 shows a digital imaging device equipped with an algorithm for self-adaptive lens shading calibration and correction;

FIG. 2 is a process diagram showing an algorithm for the self-adaptive lens shading calibration and correction according to one embodiment;

FIG. 3 shows a CMOS sensor array that is broken into various zones proceeding radially outboard from the center of the CMOS sensor array, where FIG. 3A shows a portion of FIG. 3 at an expanded scale; and

FIG. 4 is a process diagram showing an algorithm for the self-adaptive lens shading calibration and correction according to one embodiment.

### DETAILED DESCRIPTION

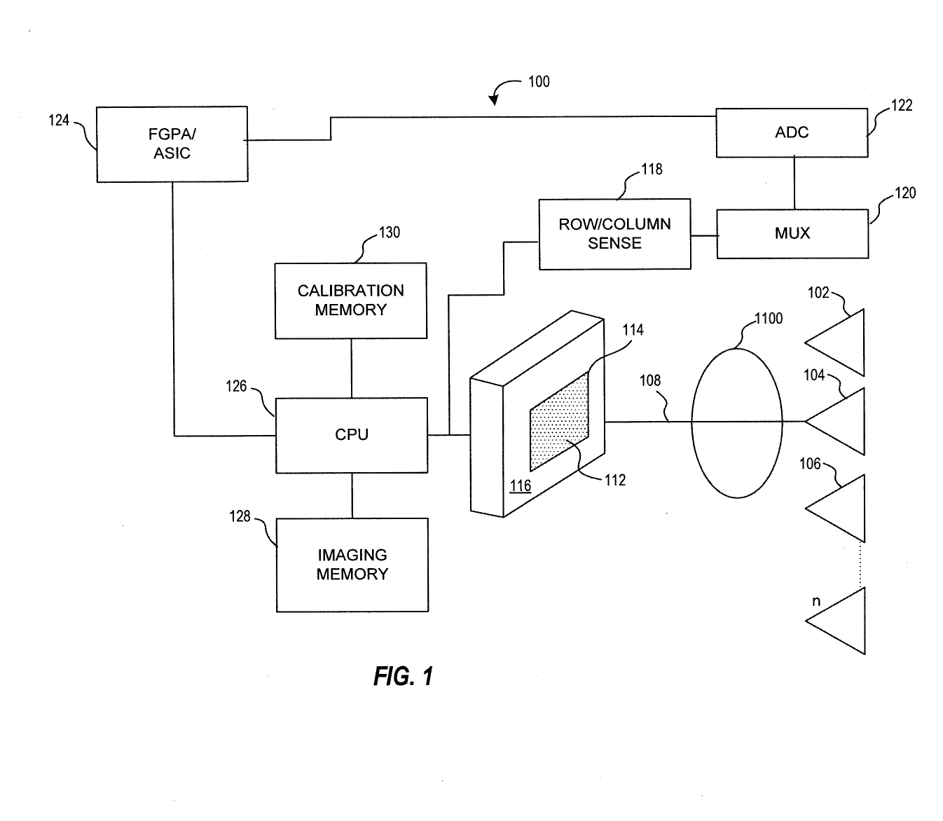

FIG. 1 is a schematic representation of a complementary metal oxide (CMOS) imaging system 100 as the imaging system is undergoing calibration. The CMOS imaging system may be a color imaging system or a monochrome imaging system, but is preferably a color imaging system. A plurality of light sources 102, 104, 106 . . . n are selectively positionable to project flatfield images, or other images, as light 108 travelling through lens 110 for impingement upon a pixelated sensor array 112. The sensor array 112 contains rows and columns of pixels 114, as is known in the art and may be, for example, a CMOS imaging array. The sensor array 112 is supported by a chip package 116 that may be purchased on commercial order. The impingement of light upon sensor array 112 generates a pixelated image signal by operation of conventional row/column sense circuitry 118. The signal is next multiplexed by analog MUX 120 then converted to digital by analog to digital converter 122.

As shown in the embodiment of FIG. 1, the pixelated image signal from ADC 122 is multiplied by a pixel-specific compensation factor stored in a field programmable gate array or ASIC 122. This compensation factor compensates for lens shading and results from a process described below. A processor 126 receives the digital signal from FPGA 124 for image processing and stores the processed signal as an image in imaging memory 128. It will be appreciated that FPGA 124 accelerates processing that might, otherwise, occur on the processor 126. Calibration memory 130 is a subset of memory that stores the calibration factors for each pixel.

The chip package 116 with the CMOS sensor array 112 is coupled with circuitry and housing structure (not shown) facilitating the operation thereof as a camera, scientific instrument, medical imaging device, or other type of digital imaging system.

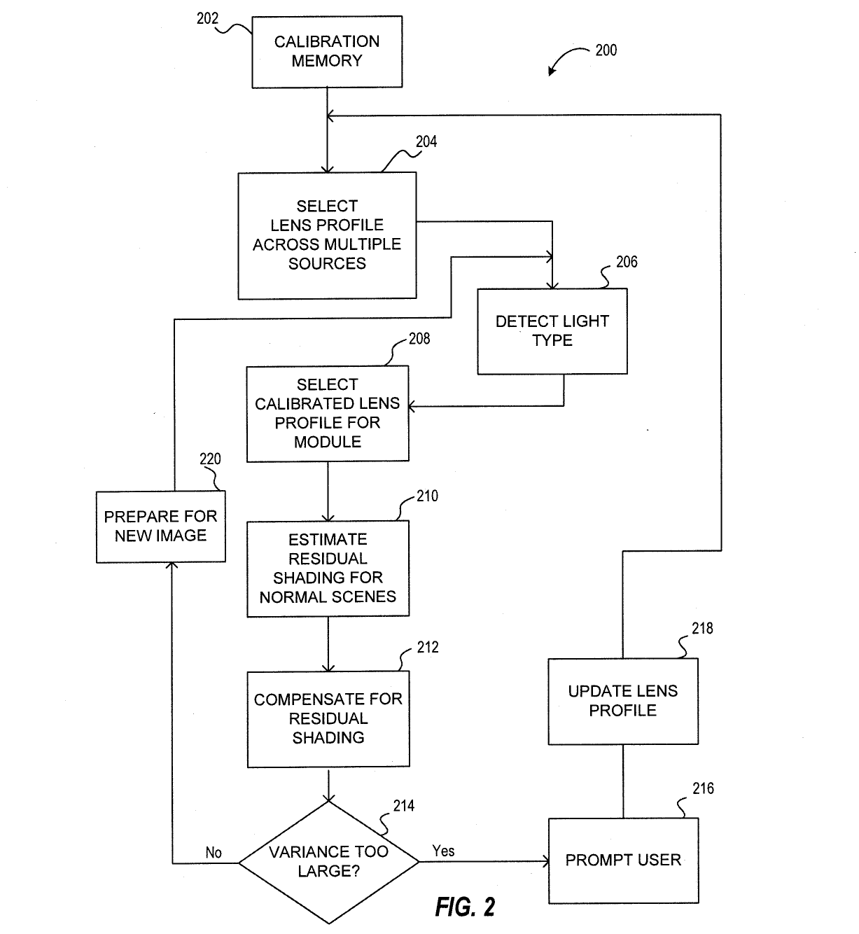

FIG. 2 is a diagram of process 200, which is used to produce the pixel-specific calibration factors for use in lens shading calibrations as discussed above. It will be appreciated that modules, such as chip package 116 shown in FIG. 1, may share common lens profiles. Thus, step 202 entails selecting a particular lens profile from among a plurality of such profiles. The lens profile 204 is calibrated across multiple light sources, for example, where the industry commonly uses D65, CWF and Type A flat field sources. This initial calibration may proceed in any manner known to the art. It will be appreciated in one aspect that it is possible to have a library of calibrations for a particular type of module, and that the calibrations may be transferred in step 204 to an individual module of that type without having to perform an actual calibration by exposing that individual module to actual light sources 104-106.

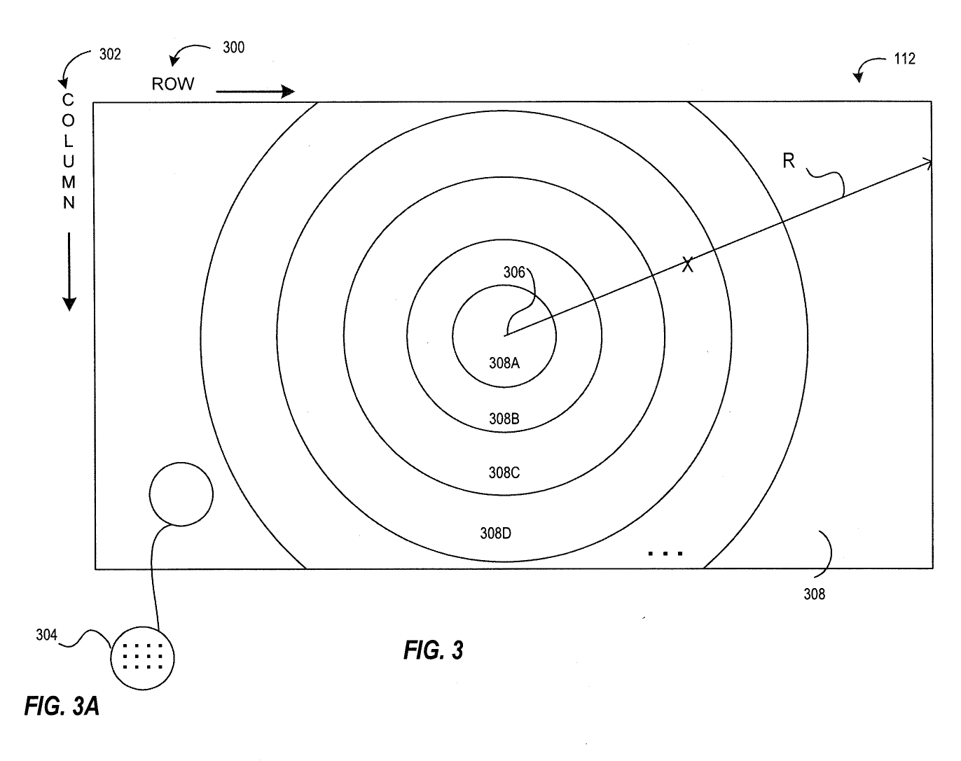

In step 206, the imaging device detects an ambient light type as the imaging device operates in the intended environment of use. This may be done, for example, on a smoothed basis by dividing the sensor array 112 into various fields, for example, as shown in FIG. 3. The sensor array presents rows 300 and columns 302 of pixels 304. FIG. 3A is an expanded section of FIG. 3 showing plurality of pixels 304 organized in this row/column format. The sensor array 112 may be subdivided into different zones 308A, 308B, 308C, 308D . . . . 308ₙ extending from array center 306 in a radially outboard direction R. Due to the aspect ratio, it will be appreciate some of the zones, such as zone 308n, may be truncated into respective arcs. Each such zone will have corresponding ones of pixels 304 residing therein, and each pixel will produce a signal of a certain intensity depending upon its location and the light impinging upon the sensor array 112.

The signal intensity values for each pixel may be delimited by deleting values that are over a maximum threshold value and less than a minimum threshold value. In one aspect, the maximum threshold value and the minimum threshold values may have the same magnitude to exclude the same number of points on the high and low side of the spectrum, for example, as when excluding data points on the basis of those that are outside a standard deviation. The remaining points may be averaged for each zone or a modal value may be selected. The average or modal value may be curve fit to provide an empirical equation that is subsequently used to estimate calibration factors for lens shading corrections. This may be, for example, a first or second order least squares fit that defines an equation for a relationship that progresses on a line in direction R where equidistant points on that line all have the same calibration factor. This empirical equation may be used to determine calibration factors for each pixel by use of the following Equation (1):

F=f(C)/f(X), (1)

where F is the calibration factor, f(C) is the value of the empirical equation at the center point 306, f(X) is the value of the empirical equation for each pixel at a distance, such as distance X from center 306 along direction R.

This procedure may be duplicated for each light type using data taken in the calibration step 204. It will be appreciated that other calculation techniques may be applied to the same effect of calculating calibration factors as one proceeds radially outboard from center 306 along direction R. For example, the calibration factors may be contoured along iso-factor lines. Returning now to FIG. 2, the light type may be detected 206 as the type associated with correlation coefficients from step 204 that most closely match the correlation coefficients from step 206.

The detected light type from step 206 is used to select 208 a calibrated lens profile for use in imaging. This lens profile is used to estimate 210 residual shading for scenes that are captured in the normal environment of use. By way of example, these scenes could be taken of a zoo or a park, or as a portrait of an individual, and then the image is actually compensated 212 for lens shading according to this lens profile.

If the system determines 214 on the basis of comparing coefficients from the empirical correlation in use that the variance is too large between this lens profile and that produced by the empirical equation from step 206, the system optionally prompts 216 the user to update 218 the lens profile. Thus, the empirical correlation from step 206 is used to create a lens profile by assigning a calibration factor to each pixel. This new lens profile is stored for future use in step 204. If the variance is not too large, for example, as being beneath a threshold comparison value, then the system prepares 220 to take a new image.

The foregoing calibration process may be performed on an uncalibrated image signal or upon an image signal that has been previously corrected by calibration. In the case where the signal has been previously corrected, the calibration factor from the above process may be multiplied by the previous calibration factor for a particular pixel to arrive at a combined overall calibration factor.

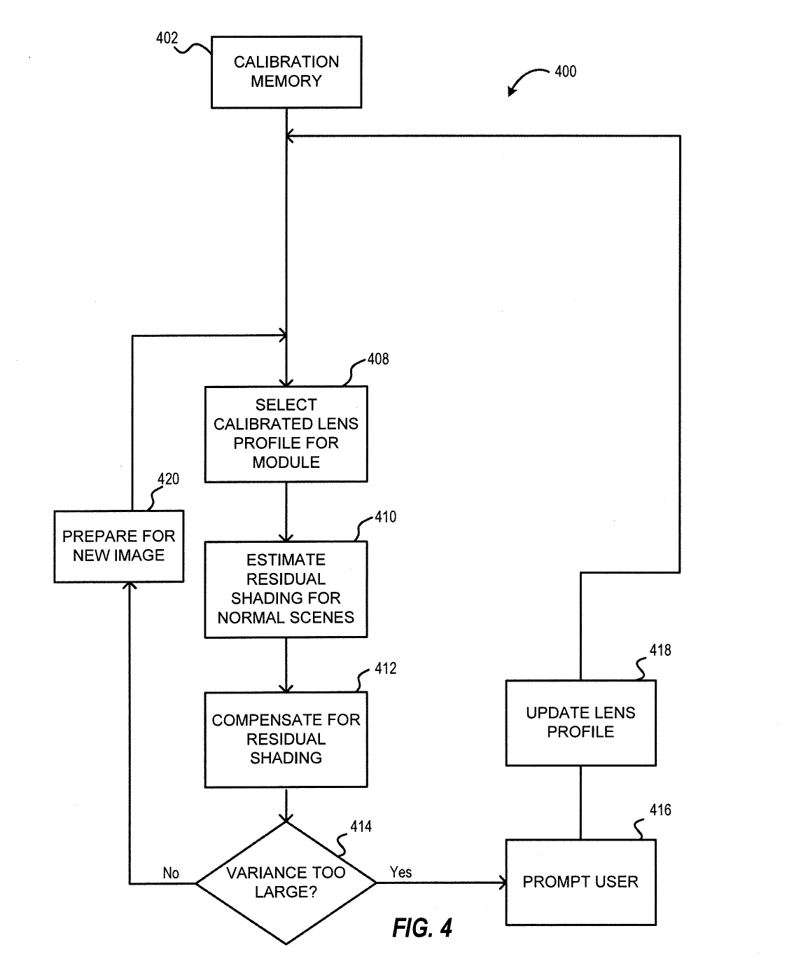

Another option is to use a dynamic shading estimating method to choose the best matched profile instead of using color temperature. This entails choosing an initial lens profile, estimating a residual lens shading in a radially outboard direction, and then changing the profile to minimize the residual and so also compensate for the residual lens shading. This is shown in FIG. 4, which resembles the process diagram of FIG. 2 but is conducted essentially without an equivalent to process steps 204 and 206.

FIG. 4 is a diagram of process 200, which is used to produce the pixel-specific calibration factors for use in lens shading calibrations as discussed above. Here a processor accesses calibration memory 402, which may contain a single lens calibration profile or a library of such profiles. There is no need to use a lens profile that is calibrated across multiple light sources and to select a calibration option based upon ambient light type. For example, steps 204 and 206 of FIG. 2 are not required, although the use of a profile achieved in this manner is not necessarily precluded.

Step 408 entails selecting an initial calibrated lens profile from the calibration memory. This lens profile is used to estimate 410 residual shading for scenes that are captured in the normal environment of use. By way of example, these scenes could be taken of a zoo or a park, or as a portrait of an individual, and then the image is actually compensated 412 for lens shading according to this lens profile.

If the system determines 414 on the basis of comparing coefficients from the empirical correlation in use that the variance is too large between this lens profile and the initial calibrated lens profile from step 414, the system optionally prompts 416 the user to update 418 the lens profile. This new lens profile is stored for future use in step 404. If the variance is not too large, for example, as being beneath a threshold comparison value, then the system prepares 420 to take a new image

Those skilled in the art will appreciate that the various embodiments shown and described may be subjected to insubstantial changes without departing from the scope and spirit of what is claimed. Therefore, the inventors hereby state their intent to rely upon the Doctrine of Equivalents, in order to protect their full rights in the invention.

We claim:

1. A CMOS imaging system comprising:
a housing support structure;
a CMOS sensor array mounted on the housing support structure;
at least one lens configured to direct light towards the CMOS sensor array;
circuitry governing operation of the CMOS sensor array,
the circuitry being operably configured with program instructions for calibrating lens shading, the program instructions being operable for
applying a predetermined calibrated light profile to correct for lens shading;
estimating residual lens shading in a radially outboard direction taken generally from a center of the CMOS sensor array to produce a shading estimate;
compensating for the residual lens shading under ambient light by use of the shading estimate; and
updating a lens profile under current light type to reflect compensation of the residual lens shading profile.

2. The CMOS imaging system of claim 1, wherein the program instructions further provide for refining the lens profile with successive capture of additional images.

3. The CMOS imaging system of claim 1, wherein the CMOS imaging system is a digital camera.

4. The CMOS imaging system of claim 1, wherein the CMOS imaging system is a medical instrument.

5. The CMOS imaging system of claim 1, wherein the CMOS imaging system is a scientific instrument.

6. The CMOS imaging system of claim 1, wherein the CMOS sensor array is capable of detecting light in a manner that distinguishes colors in a multispectral image.

7. The CMOS imaging system of claim 1, wherein the program instructions for updating a lens profile under current light type include prompting a user to confirm the update.

8. The CMOS imaging system of claim 1, wherein the program instructions for applying a predetermined calibrated light profile include selecting the predetermined calibrated light profile based upon detecting a light type from ambient light in a normal imaging environment apart from a calibration setup.

9. A method of calibrating a CMOS imaging system to correct for lens shading; comprising:
applying a predetermined calibrated light profile to correct for lens shading;
estimating residual lens shading in a radially outboard direction taken generally from a center of a CMOS sensor array to produce a shading estimate;
compensating for the residual lens shading under ambient light by use of the shading estimate; and
updating a lens profile under current light type to reflect compensation of the residual lens shading profile.

10. The method of claim 9, wherein the step of detecting the light type includes using a CMOS sensor array to determine that the light includes different colors in a multispectral image.

11. The method of claim 9, wherein the step of updating the lens profile includes prompting a user to confirm the update.

12. The method of claim 9, wherein the step of applying a predetermined calibrated light profile includes
detecting a light type from ambient light in a normal imaging environment apart from a calibration setup, and
applying the predetermined calibrated light profile to correct for lens shading according to the detected light type.
